(19) United States
(12) Patent Application Publication
(10) Pub. No.: US 2017/0024243 A1
(43) Pub. Date: Jan. 26, 2017

(54) BACKGROUND TASK MANAGEMENT

(71) Applicant: Microsoft Technology Licensing, LLC, Redmond, WA (US)

(72) Inventors: Arun U. Kishan, Kirkland, WA (US); Pedro Miguel Sequeira de Justo Teixeira, Kirkland, WA (US); Arsalan Ahmad, Redmond, WA (US); Alain Gefflaut, Kirkland, WA (US); James Schwartz, JR., Seattle, WA (US)

(21) Appl. No.: 14/805,931

(22) Filed: Jul. 22, 2015

(51) Int. Cl. G06F 9/46

(52) U.S. Cl. CPC G06F 9/46

(57) ABSTRACT

One or more systems and/or techniques are provided for background task management. A background manager may receive a notification from a background task that the background task is waiting for an event, and may also receive a waitable object from the background task, where the waitable object is used by the background task to wait for the event. Responsive to the waitable object not being triggered within a period of time, the background manager may implement a power management policy for a computing device hosting the background task.

### BACKGROUND

Many computing devices, such as desktops, laptops, smart phones, and tablets, are developed around conserving power consumption and/or extending battery life. In an example, a mobile device may be transitioned into a connected standby state. While in the connected standby state, a screen of the mobile device is powered off along with low priority functionality (e.g., a videogame, a calculator app, and a camera app may be placed in a sleep state). Other higher priority functionality may remain operable (e.g., an incoming message notification service may be placed in a lower power operational state in order to detect incoming messages so that the mobile device may awaken into an up-to-date state with regard to new messages and/or other data).

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for background task management are provided herein. In an example of a system for background task management, a background manager is configured to receive a notification from a background task that the background task is waiting for an event. The background manager is configured to receive a waitable object used by the background task to wait for the event, from the background task. The background manager is configured to implement a power management policy for a computing device hosting the background task responsive to the waitable object not being triggered within a period of time.

In an example of a method for background task management, a waitable object, used by a background task to wait for an event, is created. The waitable object is passed to an IO manager. An IO request is issued, through the IO manager, to an IO component configured to trigger the event. The waitable object is sent to a background manager, and a notification is then sent to the background manager that the background task is waiting for the event. The notification triggers the background manager to implement a power management policy for a computing device hosting the background task responsive to the waitable object not being triggered within a period of time.

In an example of a method for background task management, a notification is received from a background task that the background task is waiting for an event. A waitable object, associated with the event, is received. The waitable object is used by the background task to wait for the event. A power management policy is implemented for a computing device hosting the background task responsive to the waitable object not being triggered within a period of time.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of background task management for power conservation of a computing device.

FIG. 2 is a flow diagram illustrating an exemplary method of background task management.

FIG. 3 is an illustration of an example of background task management.

FIG. 4A is a component block diagram illustrating an exemplary system for background task management, where a background task creates a waitable object.

FIG. 4B is a component block diagram illustrating an exemplary system for background task management, where a background task issues an IO request.

FIG. 4C is a component block diagram illustrating an exemplary system for background task management, where a background task sends a notification and a waitable object to a background manager.

FIG. 4D is a component block diagram illustrating an exemplary system for background task management, where a background task is suspended and a system on chip is transitioned into a lower power state.

FIG. 4E is a component block diagram illustrating an exemplary system for background task management, where a background task is resumed to process data associated with an event.

FIG. 5 is an illustration of an exemplary computer readable medium wherein processor-executable instructions configured to embody one or more of the provisions set forth herein may be comprised.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more systems and/or techniques for background management for power conservation of a computing device are provided herein. Many users may prefer computing devices, such as a mobile device (e.g., a smart phone, a tablet, etc.), with relatively long lasting battery life. Some computing devices may provide and/or be configure to operate at a lower power state to conserve power consumption and improve battery life (e.g., circuitry, such as a system on chip, within a computing device may be transitioned into the lower power state in order to reduce power consumption by such circuitry). While in the lower power state, background tasks may be terminated (e.g., removed from memory). Unfortunately, when transitioning the computing device back into an operational state, a significant amount of resources and/or overhead may be wasted in creating a new background task to take over where the terminated background task left off, which may be exacerbated where the frequency of incoming events is relatively high. As provided herein, background tasks may be managed in a power efficient manner that enables long running background tasks while still allowing the computing device to transition into the lower power state. That is, a cooperative model is used where a background task informs a background manager that the background task is waiting for an event so that the background manager may more aggressively power manage the computing device when a background task is running and/or additionally allow for a long-running background task model that does not suffer from overhead and/or costs of frequent short-running background tasks. For example, a background task may notify a background manager that the background task is waiting for an event (e.g., availability of data from a sensor such as a camera or accelerometer; receipt of an email through a network card/socket; etc.). While waiting for the event, the background task may be suspended (e.g., retained in memory, as opposed to being terminated, for quick and efficient resumption) and the computing device, such as a system on chip, may be transitioned into the lower power state for power conservation. Upon occurrence of the event, the computing device may be transitioned into a powered up or higher power state and the background task may be resumed to process data associated with the event. In this way, power consumption of the computing device may be conserved and/or occur more efficiently. For example, less power is consumed by suspending the background task and resuming the background task (e.g., the computing device does not need to be in a higher power state for the whole lifetime of the background task) as compared to terminating the background task and creating a new background task and/or keeping the computing device at a higher power state for the lifetime of the background task.

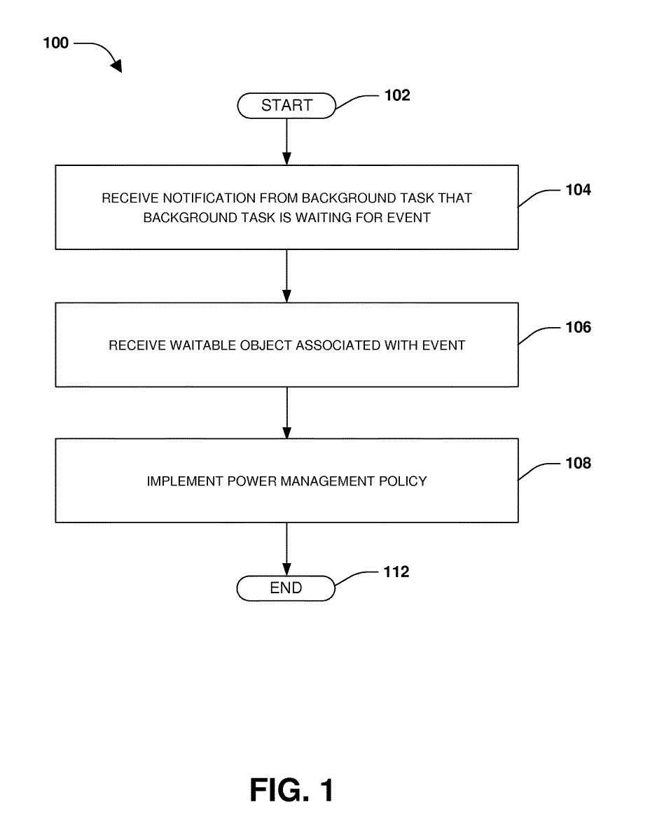

An embodiment of background task management for power conservation of a computing device is illustrated by an exemplary method 100 of FIG. 1. At 102, the method starts. A computing device (e.g., a tablet, smartphone, a wearable device, a laptop, etc.) may host one or more applications that may perform various functionality through background tasks (e.g., a wearable device configured to receive and evaluate heartbeat signals from a heartbeat monitor of the wearable device indicative of a heartrate of a user of the wearable device). During processing, a background task may come to a point where the background task is waiting for an event to occur. For example, a heartrate evaluation background task may be blocked from making further progress until a new heartbeat signal is received for processing. In another example, the event may comprise an external event associated with a sensor event (e.g., information received from a sensor such as a camera, a speaker, an accelerometer, a GPS device, etc.), a device driver, an IO hardware event of an IO component managed by an IO manager (e.g., a network card), and/or an availability of data event (e.g., receipt of a network data packet). At 104, a notification may be received (e.g., by a background manager) from a background task that the background task is waiting for the event. For example, the background manager may expose an API through which the background task can pass the notification and/or other information (e.g., waitable objects) to the background manager. The notification may specify that the background task is agreeable to be suspended until the event occurs.

At 106, a waitable object associated with the event may be received. The waitable object may be used by the background task to wait for the event. For example, the waitable object may be received from the background task (e.g., the background manager may receive a handle for the waitable object). In an example, the waitable object may have been exposed or provided, by the background task, to an IO manager (e.g., the IO manager may have opened a connection, on behalf of the background task, to an IO component that is to monitor for the event, and may have passed the waitable object and IO request from the background task to the IO component), a device driver, or any other component that may provide the background task with data associated with an occurrence of the event. The waitable object may comprise an operating system object, such as a synchronization object (e.g., an event object), that can be signaled/triggered based upon an occurrence of the event (e.g., the IO component and/or the IO manager may trigger the waitable object upon occurrence of the event). In an example, the waitable object may be identified as being in a reset state indicating that the background task has reset the waitable object and that the background task is to issue an IO request, through the IO manager, to the IO component. The IO request may correspond to a request for data associated with the event.

At 108, a power management policy may be implemented responsive to the waitable object not being triggered within a (e.g., predefined, event driven, circumstantial, etc.) period of time, which is indicative of the event not occurring, and where the period of time may be of a very short duration including immediately or zero time (e.g., to aggressively manage power consumption while also maintaining performance requirements). That is, for example, the background task is waiting for an (e.g., external) event. The background task passes the waitable object to the background manager, where such passage of the waitable object by the background task to the background manager provides an indication to the background manager that the background manager can more aggressively power manage the computing device, such as by putting the computing device into a lower power state until the waitable object is triggered, where such triggering of the waitable object is indicative of the event occurring. In an example of implementing the power management policy, the background task may be transitioned (e.g., by the background manager) into a low priority state (e.g., a suspended state, a lower scheduling priority, etc.). In an example, the background task may be retained in memory while in a suspended state so that the background task may be quickly and efficiently resumed at a later point in time (e.g., otherwise, terminating the background task may result in significant processing overhead when creating a new background task to take over where the terminated background task left off). In an example of determining whether to suspend the background task, resources of the computing device may be evaluated to identify a resource availability metric (e.g., memory availability). Responsive to the resource availability metric exceeding a resource threshold, the background task may be suspended. Otherwise, the background task may be terminated instead of being suspended (e.g., due to a lack of resource availability).

In another example of implementing the power management policy, a system on chip (e.g., circuitry of the computing device) may be transitioned into a lower power state, for power conservation of the computing device, until the event occurs, which may significantly reduce power consumption by the computing device, and likely improve battery life. For example, an IO component and/or IO manager may trigger the waitable object based upon an occurrence of the event (e.g., a heartbeat signal being received). Responsive to the event occurring (e.g., the waitable object being triggered by the IO manager), the system on chip may be transitioned into a higher power or powered up state (e.g., such that the background task may be resumed to process data associated with the event). In another example of implementing the power management policy, the computing device may be transitioned into a lower power state, one or more components of the computing device may be powered down, a thread scheduling policy may be implemented, and/or other power management functionality may be implemented based upon the power management policy. In this way, energy may be conserved while the background task is waiting for events. At 114, the method ends.

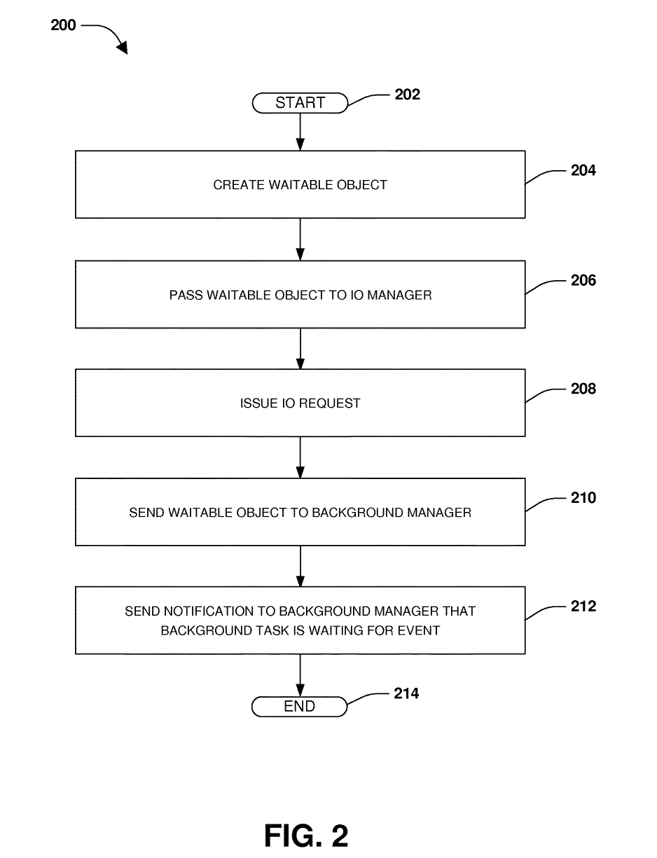

An embodiment of background task management is illustrated by an exemplary method 200 of FIG. 2. At 202, the method starts. At 204, a waitable object, used by a background task to wait for an event to occur, may be created, such as by the background task. At 206, the waitable object may be passed, such as by the background task, to an IO manager (e.g., hardware and/or software such as a driver that manages IO hardware, such as sensors, peripherals, communication devices, network cards, GPS devices, etc.), a device driver, or any other component that may provide data to the background task based upon an occurrence of the event. At 208, an IO request may be issued, through the IO manager, to an IO component configured to facilitate the event (e.g., a heartbeat sensor). In an example, the waitable object may be reset, such as by the background task, before the IO request is sent.

At 210, the waitable object (e.g., a handle for the waitable object) may be sent, such as by the background task, to the background manager (e.g., so that the background manager may evaluate a state of the waitable object (e.g., a triggered state or an untriggered state) in order to determine whether the event has occurred). At 212, a notification may be sent, such as by the background task, to the background manager that the background task is waiting for the event using the waitable object. The notification may trigger the background manager to implement a power management policy for a computing device hosting the background task responsive to the waitable object not being triggered within a (e.g., predefined, event driven, circumstantial, etc.) period of time. In an example of implementing the power management policy, the background task may be transitioned into a low priority state (e.g., a suspended state, a lower scheduling priority, etc.) based upon the waitable object being in an untriggered state. In an example, the background task may be retained in memory while in a suspended state. In another example, a system on chip (e.g., circuitry or other hardware), of a computing device hosting the background task, may be transitioned into a lower power state, for power conservation of the computing device, based upon the waitable object being in the untriggered state. In another example, the computing device may be transitioned into a lower power state, one or more components of the computing a device may be powered down, a thread scheduling policy may be implemented, and/or other power management functionality may be implemented based upon the power management policy.

In an example, the background task may be resumed into an operational state based upon the waitable object being triggered (e.g., a heartbeat signal being received). Responsive to being resumed into the operational state, the background task may process data, associated with the event, from the IO component. In an example, the system on chip may be transitioned into a higher power or powered up state for operation based upon the event occurring. At 218, the method ends.

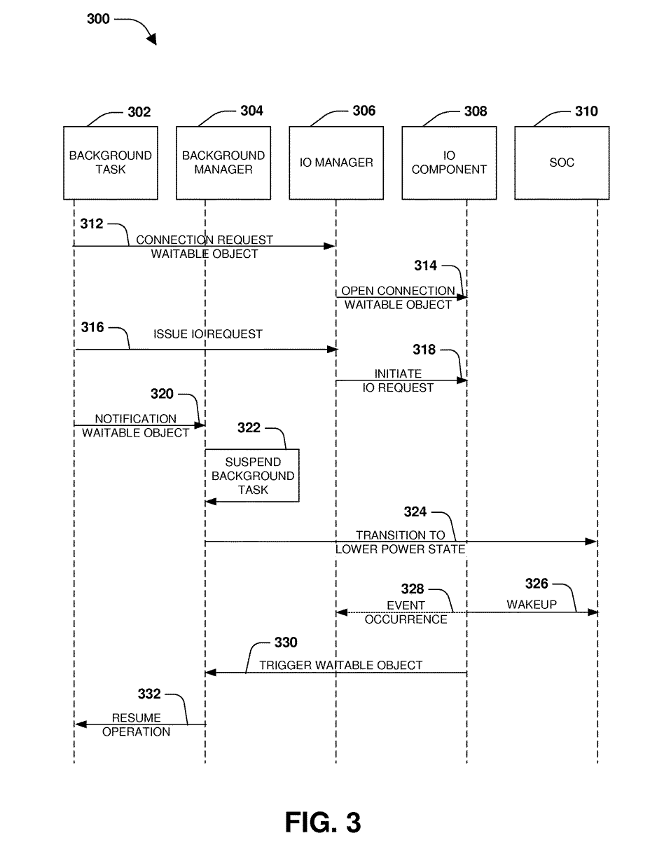

FIG. 3 illustrates an example 300 of background task management. A background task 302 (e.g., a movement detection background task of a security application) may send 312 a connection request and waitable object to an IO manager 306, that manages an IO component 308 (e.g., a camera), based upon the background task 302 requesting information from the IO component 308 (e.g., the movement detection background task may be waiting for a capture event of a photo triggered by movement detected by a computing device hosting the security application). The IO manager 306 may open 314 a connection to the IO component 308, and may pass the waitable object to the IO component 308. The background task 302 may issue 316 an IO request to the IO manager 306 (e.g., a request to obtain the photo when the photo becomes available from the camera). The IO manager 306 may initiate 318 the IO request with the IO component 308.

Because the photo may not become available until the computing device detects movement and thus invokes the camera to capture the photo, power consumption of the computing device may be reduced by transitioning a system on chip 310 (e.g., hardware of the computing device) into a lower power state until the capture event occurs. Accordingly, the background task 302 may send 320 a notification and the waitable object to a background manager 304. The notification may specify that the background task 302 is agreeable to be suspended until the capture event occurs, and thus may trigger the background manager to implement a power management policy (e.g., immediately, after a time duration, etc.). In this way, the background manager 304 may suspend 322 the background task 302. In an example, the background task 302 may be retained in memory while suspended. The background manager 304 may transition 324 (e.g., immediately, after a time duration, etc.) the system on chip 310 into the lower power state, for power conservation of the computing device, until the capture event occurs.

Upon occurrence of the capture event (e.g., the computing device may detect movement and the camera may capture the photo), the system on chip 310 may wakeup 326 and the IO component 308 may notify 328 the IO manager 306 of the occurrence of the capture event. The IO component 308 may trigger 330 the waitable object. Responsive to the waitable object being triggered, the background manager 304 may resume 332 operation of the background task 302 for processing the photo.

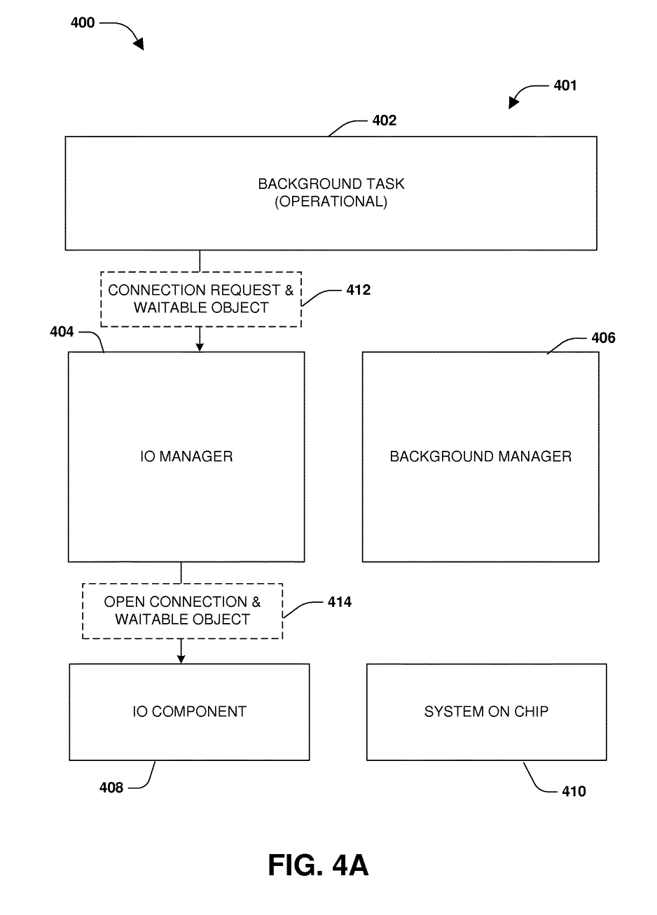

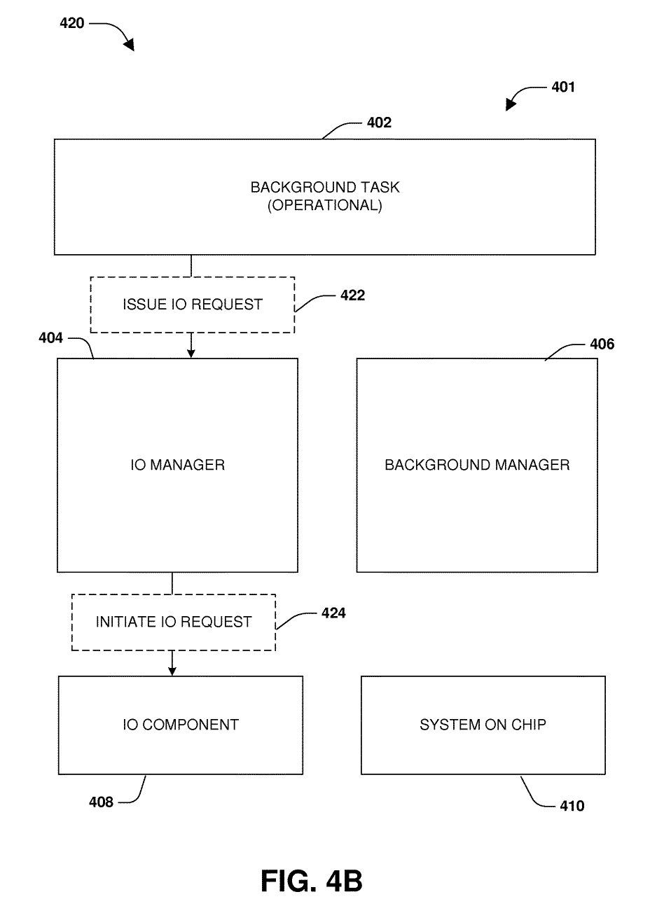

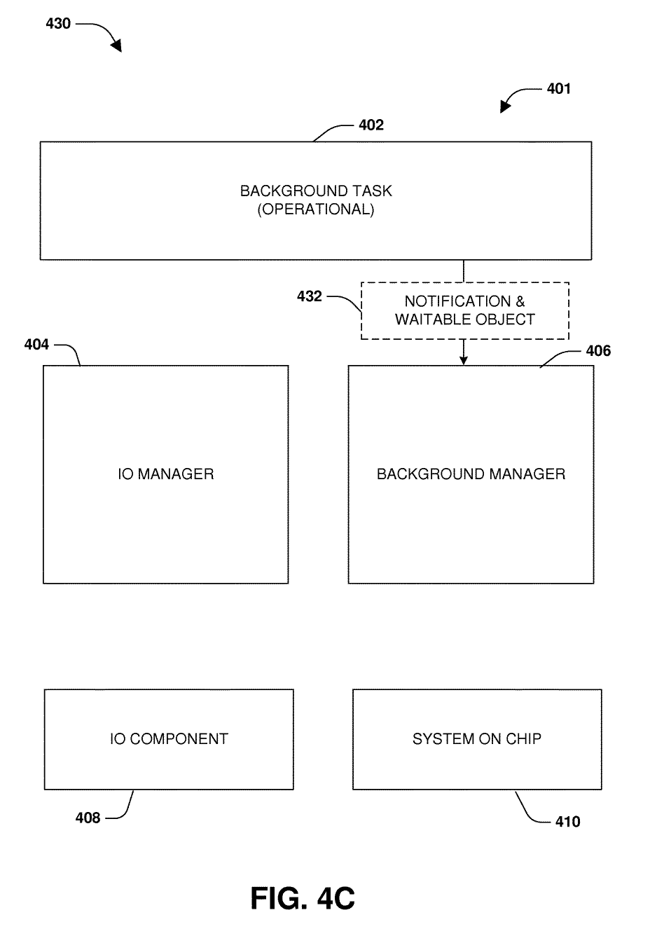

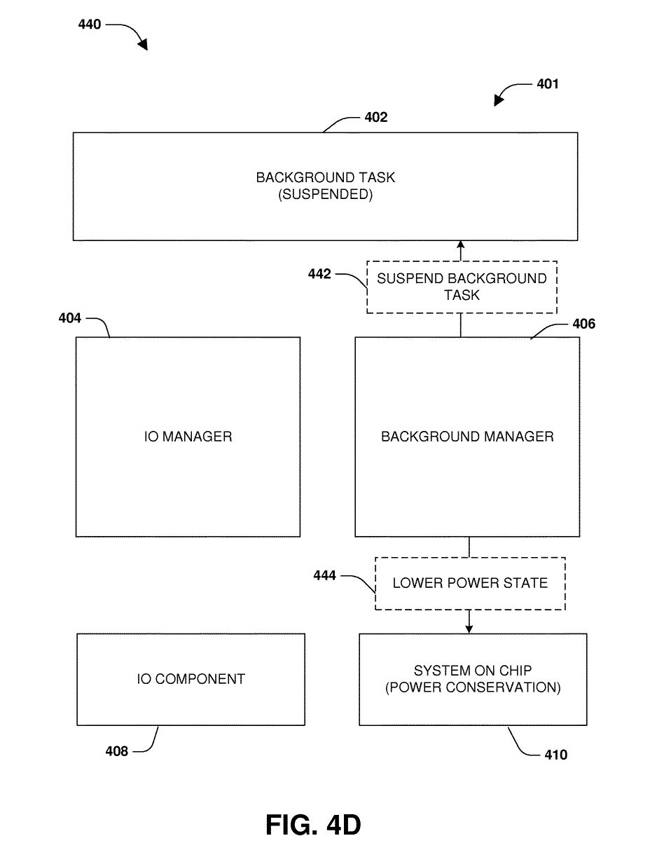

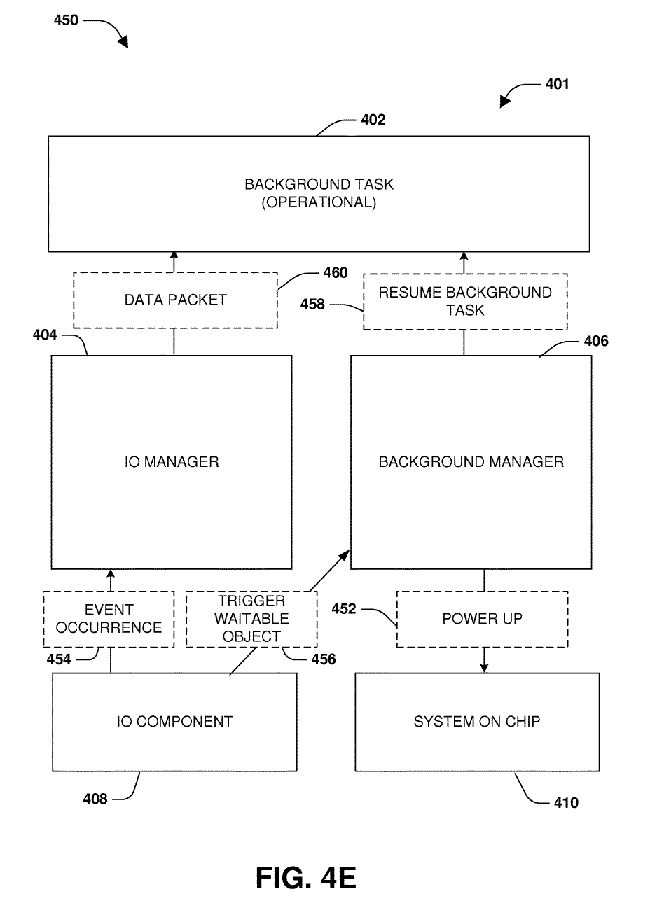

FIGS. 4A-4E illustrate examples of a system 401 for background task management. FIG. 4A illustrates an example 400 of a computing device comprising a system on chip 410 (e.g., hardware of the computing device), an IO component 408 (e.g., an input device such as a touch display or mouse, a sensor such as a camera, a network card, etc.), an IO manager 404 (e.g., hardware and/or software used as an abstraction layer for interfacing with the IO component 408), a background manager 406, and/or a background task 402. In an example, the background task 402 may comprise a data migration background task that is configured to migrate a data volume from a first data server to a second data server. The background task 402 may send 412 a connection request and waitable object to the IO manager 404. The waitable object may correspond to an event, such as a volume migration status notification (e.g., a success or failure notification) that is to be received by a network card IO component, for which the background tasks is waiting (e.g., the background task 402 may be blocked from performing further processing until the migration status notification is received). The IO manager 404 may open 414 a connection with the IO component 408, such as the network card IO component, and may pass the waitable object to the IO component 408.

FIG. 4B illustrates an example 420 of the background task 402 issuing 422 an IO request (e.g., a request for a data packet, corresponding to the migration status notification, which may be received by the network card IO component). The IO manager 404 may initiate 424 the IO request with the IO component 408. Because the volume migration may take a substantial amount of time (e.g., minutes, hours, days, etc.), it may be advantageous to transition the computing device, such as the system on chip 410, into a lower power state, for power conservation, while the background task 402 is waiting for the occurrence of the event (e.g., the receipt of the data packet by the network card IO component).

FIG. 4C illustrates an example 430 of the background task 402 sending 432 a notification and the waitable object to the background manager 406. The notification may specify that the background task 402 is waiting for the event and that the background task is agreeable to be suspended until the event occurs. FIG. 4D illustrates an example 440 of the background manager 406 implementing a power management policy, such as suspending the background task 402 into a suspended state, responsive to the waitable object not being triggered within a (e.g., predefined, event driven, circumstantial, etc.) period of time (e.g., based upon the waitable object being in an untriggered state) (e.g., the IO component 408 and/or the IO manager 404 may trigger the waitable object to signal that the event has occurred such as the network card IO component receiving the data packet comprising the migration status notification for which the background task 402 is waiting). In an example, the background manager 406 may retain the background task 402 in memory while the background task 402 is suspended. In an example of implementing the power management policy, the background manager 406 may transition 444 the system on chip 410 into a lower power state, for power conservation of the computing device, until the event occurs.

FIG. 4E illustrate an example 450 of the event occurring. For example, the IO component 408 (e.g., the network card IO component) may receive the data packet comprising the migration status notification. The IO component 408 may notify 454 the IO manager 404 of the event occurrence. The IO component 408 may trigger 456 the waitable object, which may be detected by the background manager 406. Based upon the waitable object being triggered due to the event occurrence, the system on chip 410 may be powered up 452 into a higher power state and the background task may be resumed 458 into the operational state. The IO manager 404 may provide the data packet 460, comprising the migration status notification for which the background task 402 is waiting, to the background task 402 for processing.

According to an aspect of the instant disclosure, a system for background task management is provided. The system comprises a background manager. The background manager is configured to receive a notification from a background task that the background task is waiting for an event. The background manager is configured to receive a waitable object from the background task, where the waitable object is used by the background task to wait for the event. Responsive to the waitable object not being triggered within a period of time, the background manager is configured to implement a power management policy for a computing device hosting the background task.

According to an aspect of the instant disclosure, a method for background task management is provided. The method includes creating a waitable object used by a background task is to wait for an event. The method includes passing the waitable object to an IO manager. The method includes issuing an IO request, through the IO manager, to an IO component configured to trigger the event. The method includes sending the waitable object to a background manager. The method includes sending a notification to the background manager that the background task is waiting for the event using the waitable object, where the notification triggers the background manager to implement a power management policy for a computing device hosting the background task responsive to the waitable object not being triggered within a period of time.

According to an aspect of the instant disclosure, method for background task management is provided. The method includes receiving a notification from a background task that the background task is waiting for an event. The method includes receiving a waitable object associated with the event, where the waitable object is used by the background task to wait for the event. The method includes responsive to the waitable object not being triggered within a period of time, implementing a power management policy for a computing device hosting the background task.

According to an aspect of the instant disclosure, a means for background task management is provided. A notification is received from a background task that the background task is waiting for an event, by the means for background task management. A waitable object is received from the background task, by the means for background task management, where the waitable object is used by the background task to wait for the event. Responsive to the waitable object not being triggered within a period of time, a power management policy is implemented for a computing device hosting the background task, by the means for background task management.

According to an aspect of the instant disclosure, a means for background task management is provided. A waitable object, used by a background task to wait for an event, is created, by the means for background task management. The waitable object is passed to an IO manager, by the means for background task management. An IO request is issued, through the IO manager, to an IO component configured to trigger the event, by the means for background task management. The waitable object is sent to a background manager, by the means for background task management. A notification is sent to the background manager that the background task is waiting for the event using the waitable object, by the means for background task management, where the notification triggers the background manager to implement a power management policy for a computing device hosting the background task responsive to the waitable object not being triggered within a period of time.

According to an aspect of the instant disclosure, a means for background task management is provided. A notification is received from a background task that the background task is waiting for an event, by the means for background task management. A waitable object associated with the event is received, by the means for background task management, where the waitable object is used by the background task to wait for the event. Responsive to the waitable object not being triggered within a period of time, a power management policy is implemented for a computing device hosting the background task, by the means for background task management.

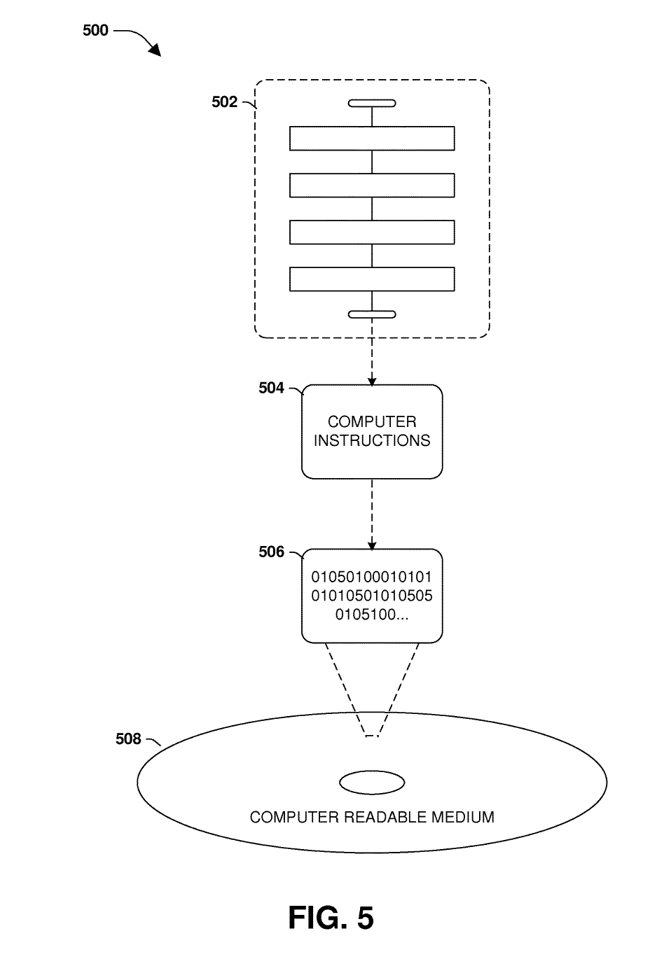

Still another embodiment involves a computer-readable medium comprising processor-executable instructions configured to implement one or more of the techniques presented herein. An example embodiment of a computer-readable medium or a computer-readable device is illustrated in FIG. 5, wherein the implementation 500 comprises a computer-readable medium 508, such as a CD-R, DVD-R, flash drive, a platter of a hard disk drive, etc., on which is encoded computer-readable data 506. This computer-readable data 506, such as binary data comprising at least one of a zero or a one, in turn comprises a set of computer instructions 504 configured to operate according to one or more of the principles set forth herein. In some embodiments, the set of computer instructions 504 are configured to perform a method 502, such as at least some of the exemplary method 100 of FIG. 1 and/or at least some of the exemplary method 200 of FIG. 2, for example. In some embodiments, the set of computer instructions 504 are configured to implement a system, such as at least some of the exemplary system 401 of FIGS. 4A-4E, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

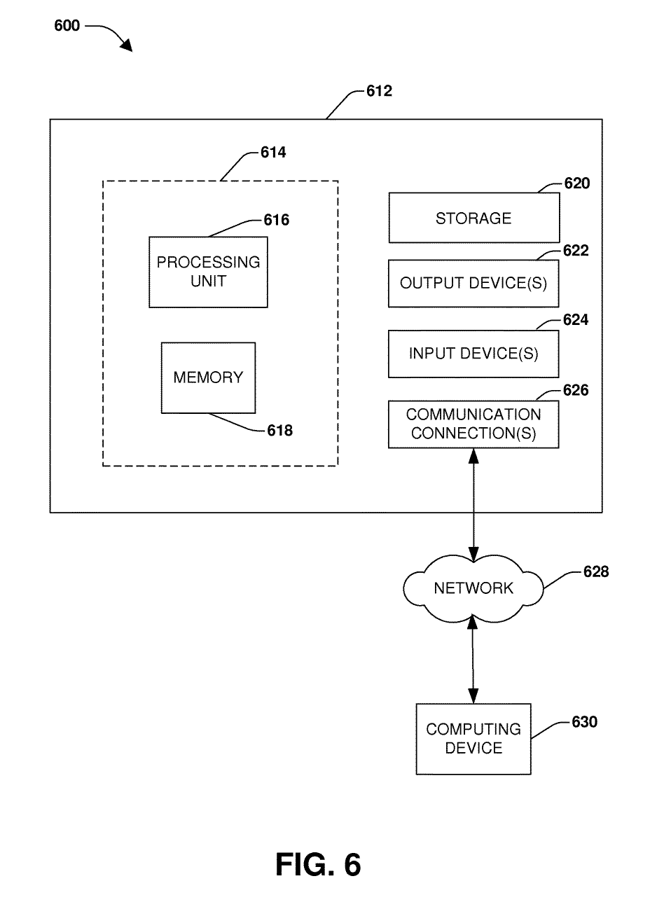

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 600 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Computer storage media does not, however, include propagated signals. Rather, computer storage media excludes propagated signals. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via a network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A computing device for background task management, comprising:
one or more processors; and
one or more computer-readable media having stored thereon computer-executable instructions that are executable to cause the one or more processors to perform at least the following:
receive, at a background manager and from a background task, a notification indicating that the background task is waiting for an event;
receive, at the background manager and from the background task, an identity of a waitable object used by the background task to wait for the event, the waitable object having been exposed to an input/output (“IO”) manager by the background task, the waitable object being triggerable by the IO manager upon an occurrence of the event; and
responsive to the waitable object not being triggered by the IO manager within a period of time, implement a power management policy for the computing device.

2. The computing device of claim 1, the computer-executable instructions also executable to cause the one or more processors to:
transition the background task into a low priority state based upon the power management policy.

3. The computing device of claim 1, the computer-executable instructions also executable to cause the one or more processors to:
transition a system on chip of the computing device into a lower power state based upon the power management policy.

4. The computing device of claim 2, the low priority state comprising a suspended state, and the computer-executable instructions also executable to cause the one or more processors to:
retain the background task in memory while in the suspended state.

5. The computing device of claim 2, the computer-executable instructions also executable to cause the one or more processors to:
responsive to the waitable object being triggered by the IO manager based upon an occurrence of the event, transition the background task from the low priority state into an operational state for processing data associated with the event.

6. The computing device of claim 3, the computer-executable instructions also executable to cause the one or more processors to:
responsive to the waitable object being triggered by the IO manager based upon an occurrence of the event, transition the system on chip from the lower power state into an operational power state.

7. The computing device of claim 1, the event comprising an external event associated with at least one of a sensor event, a communication device event, an IO hardware event of an IO component managed by the IO manager, or an availability of data event.

8. The computing device of claim 1, the computer-executable instructions also executable to cause the one or more processors to:
evaluate resources of the computing device to identify a resource availability metric; and
responsive to the resource availability metric not exceeding a resource threshold, terminate the background task based upon the power management policy.

9. The computing device of claim 1, the computer-executable instructions also executable to cause the one or more processors to:
receive, at the IO manager, an open connection request and the waitable object from the background task;
open a connection to an IO component associated with the open connection request; and
pass the waitable object to the IO component through the connection.

10. The computing device of claim 1, the computer-executable instructions also executable to cause the one or more processors to:
determine that the background task reset the waitable object into a reset state, the reset state indicating that the background task is to issue an IO request, through the IO manager, to an IO component, the IO request corresponding to a request for data associated with the event.

11. The computing device of claim 1, the computer-executable instructions also executable to cause the one or more processors to perform at least one of:
transition the computing device into a lower power state,
power down a device, or
modify a thread scheduling policy based upon the power management policy.

12. The computing device of claim 1, the computer-executable instructions also executable to cause the one or more processors to:
assign a lower scheduling priority to the background task based upon the power management policy.

13. A method, implemented at a computing device that includes one or more processors, for background task management, the method comprising:
creating a waitable object used by a background task to wait for an event;
passing an identity of the waitable object to an input/output (“IO”) manager, the waitable object being triggerable by the IO manager upon an occurrence of the event;
issuing an IO request, through the IO manager, to an IO component configured to initiate the event;
sending the identity of the waitable object to a background manager; and
sending a notification to the background manager that the background task is waiting for the event using the waitable object, the notification causing the background manager to implement a power management policy for the computing device hosting the background task responsive to the waitable object not being triggered by the IO manager within a period of time.

14. The method of claim 13, further comprising:
transitioning the background task into a low priority state based upon the power management policy.

15. The method of claim 14, the low priority state comprising a suspended state.

16. The method of claim 14, the transitioning comprising:
retaining the background task in memory while in the low priority state.

17. The method of claim 14, further comprising:
responsive to the computing device being resumed from the low priority state into an operational state based upon the waitable object being triggered, processing data, associated with the event, from the IO component.

18. A method, implemented at a computing device that includes one or more processors, for background task management, the method comprising:
receiving a notification from a background task indicating that the background task is waiting for an event;
receiving from the background task an identity of a waitable object associated with the event, the waitable object used by the background task to wait for the event, the waitable object having been exposed to an input/output (“IO”) manager by the background task, the waitable object being triggerable by the IO manager upon an occurrence of the event; and
responsive to the waitable object not being triggered by the IO manager within a period of time, implementing a power management policy for the computing device.

19. The method of claim 18, the implementing a power management policy comprising:
transitioning the background task into a low priority state based upon the power management policy; and
transitioning a system on chip of the computing device into a lower power state based upon the power management policy.

20. (canceled)

21. The system of claim 1, the period of time having been specified by the waitable object.
